(19) United States
(12) Patent Application Publication
(10) Pub. No.: US 2026/0209458 A1
(43) Pub. Date: Jul. 23, 2026

(54) FILLER OR SPACER ELEMENT FOR USE IN AUTOMOTIVE TRIM PARTS

(71) Applicant: AUTONEUM MANAGEMENT AG, Winterthur (CH)

(72) Inventors: Philippe GODANO, Winterthur (CH); Stefano SCHNAPPENBERGER, Thun (CH)

(73) Assignee: AUTONEUM MANAGEMENT AG, Winterthur (CH)

(21) Appl. No.: 19/139,560

(22) PCT Filed: Nov. 23, 2023
(86) PCT No.: PCT/EP2023/082807

§ 371 Date: Jun. 16, 2025

(30) Foreign Application Priority Data
Dec. 20, 2022 (EP) 22214791.0

(51) Int. Cl. C08J 9/232; C08K 9/08

(52) U.S. Cl. CPC C08J 9/232; C08K 9/08; C08J 2367/02; C08K 2201/002

(57) ABSTRACT

A filler element for use in automotive trim parts, characterised in that the filler element comprises expanded thermoplastic terephthalate-based polyester beads with a density of between 25 and 150 kg/m³.

This application is a national stage application under 35 U.S.C. 371 and claims the benefit of PCT Application No. PCT/EP2023/082807 having an international filing date of Nov. 23, 2023, which designated the United States, which claims the benefit of European Patent Application No. 22214791.0, filed Dec. 20, 2022, the disclosures of each of which is incorporated by reference herein.

### TECHNICAL FIELD

The invention is directed to a filler element for use in automotive trim parts, an automotive trim part comprising such a filler element and the use of such a filler element in automotive trim parts.

### BACKGROUND ART

Automotive trim parts, or soft trim parts as they are known as well, are single or multilayer parts that are mainly used in the passenger compartment for different reasons. For instance, they are used to cover body work of the vehicle, like the flooring, the inner dash or small areas at the side of the inner dash, around the tunnel or under seats as well as in the trunk area. These parts are called soft trim parts as they are composed of one or more layers of relatively soft materials like foam or fibrous layers or combinations of such layers. They may be combined with foils, films or thermoplastic elastomeric, optionally filled, layers. A combination of such layers with different density or stiffness may be used to enhance noise attenuation, to prevent water entering the part or to obtain an aesthetic, even flooring or surface.

In some areas of the trim parts there is a need for a hard and lightweight element, for instance in areas that may expect to be subjected to a heavier load; this might be in the trunk or at the area where the passenger enters the vehicle and steps on the floor. Or for instance, in areas where the passenger parks a foot or both feet. These elements might be seen as stiffening elements. However, they are also used in areas where no load force may be expected but where a larger distance between the trim part surface and the underlying vehicle body must be filled, here they may be seen as a filler or spacer element. For the sake of clarity, spacer element, filler element or a stiffening element is used for all situations where a hard and lightweight element or layer is needed, and is used interchangeably.

Expanded polypropylene (EPP), expanded polyethylene (EPE), expanded polystyrene (EPS) or a mixture of EPS and EPE, commercially known as Piocelan, are the materials that are most used for forming such hard filler elements. In most layer combinations the current hard block materials used are not compatible with recycling processes, while the scrapped waste may not be reused as a mixture. Therefore, most of these blocks or trim parts containing such blocks end up in landfill or incineration.

However, these materials have multiple drawbacks, in particular when integrated into multilayer automotive trim parts. For instance, EPS becomes known to be harmful for the environment, as it does not biodegrade in the landfill and waste incineration produces harmful gasses. Although EPP is better, it is not compatible with the other materials generally used in automotive trim parts, like polyester felt layers or polyester carpet surfaces.

The automotive industry is striving towards zero waste production processes as well as a circular material usage on the longer term. For this the trim parts need to contain a high level of recycled content as well as comprise a material mix that is easy to recycle, preferably without the necessity to take the layers apart. The EPS or EPP blocks may be embedded in a soft polyurethane foam or a soft fibrous felt.

There is a need for an alternative material to the expanded polystyrene or expanded polyethylene that may be integrated in automotive trim parts or used in combination with automotive trim parts.

Another problem of EPS and EPP is the lack of compatibility with other materials, therefore it is difficult to bond other layers to its surface; very often the hard blocks or spacer elements are mechanically held in place. In addition, after forming the block it is near to impossible to reshape the part other than mechanically, such as cutting.

The industry is in particular striving to mono-material multilayer trim parts. So far only main layers were adapted, but accessories embedded into the flooring construction, for instance a foot rest in the form of a hard block at the driver site, or filler elements were kept unchanged. For instance, the footplate is traditionally made of metal or an acrylonitrile butadiene styrene (ABS) plastic to obtain a high impact strength.

Although the main flooring system may be made of a mono-material layering based on polyester, the accessories used are not compliant with this overall mono-material direction.

So far, the industry has struggled to find alternatives that satisfy the necessary requirements, in particular the product requirements as well as the waste management requirements without the need of removing them from the trim part or a need of waste separation.

It is the goal to provide an alternative solution for hard elements like filler elements or spacer elements to increase the recyclability of the overall trim part in particular to reduce separation steps and waste streams.

### SUMMARY OF INVENTION

The goal is achieved with a filler element according to claim 1, an automotive trim part comprising the filler element according to claim 6 and the use of the filler element in automotive trim parts according to claim 13.

In particular with a filler element comprising thermoplastic expanded terephthalate-based polyester beads with a density of between 25 and 150kg/m³, it is possible to create an alternative to the current used materials, providing for a filler, spacer or stiffening element that is more sustainable and may be recycled together with other layers, even with mixed materials due to the chemical compatibility.

Surprisingly, it is possible to create molded structures with thermoplastic polyester bead foam that surpass all requirements of filler elements for trim parts used in the passenger compartment of a car. These parts need to be lighter and less stiff than when used at the exterior or as structural parts.

Filler elements may be used in different trim parts placed in a passenger compartment of a car, for instance in a flooring system or as a foot rest block integrated in an inner dash. They may be used as spacer or filler blocks to fill in larger gaps between the vehicle body and the surface of the trim part.

The filler element may be used as such or integrated in one or more additional layers. The block is attached to, bound to, or encapsulated in one or more additional layers, for instance at least one of a foam layer, felt layer, film layer, thermoplastic layer, highly filled thermoplastic elastomeric layer, or a carpet.

Preferably the filler element is molded into a 3D shape, preferably including at least one of ribs, voids, protrusions, channels or domes.

The filler element may be shaped or curved or in a U-shaped configuration, or comprising a recess for other elements of the trim part in order to conform to the body of the vehicle, the surface needed or to other trim parts. The filler element may be molded to provide a cavity for an auxiliary battery, for example those used under the seat.

The filler element preferably has a higher compressional stiffness than the surrounding layer or layers.

For example, the filler element may be placed upon the body of a car and covered with a carpet system, formed by a pile of tufts tufted into a primary backing whereby the tufts are locked in place by a thermoplastic layer attached to the surface of the primary backing opposite the pile surface and with a secondary backing adjacent and bonded to the thermoplastic layer. To prevent the filler element from moving, it might be enclosed by at least one additional layer, for instance a felt and/or foam layer. The block may be foamed around, preferably with a polyurethane foam. To further enhance the locking of the filler element in place the block may have a 3D shape that not only fits the space to be filled but also comprises ribs, domes or voids to further enhance the locking of the part. The thus enclosed stiffening block may be adjacent and bound to the tufted carpet system by the enclosing layer, for instance during a back foaming process or by the binder of the fibrous felt layer. Surprisingly, already a few spacer filler blocks locally integrated in a carpet system with a backing layer formed by a felt or foam, whereby the block is integrated in the backing layer, increase the compressional stiffness enough to enable a stepping on the flooring system without sinking in, while maintaining the thickness and softness of the backing layer needed for acoustics and reducing the overall density and weight of the full flooring trim part.

In a preferred solution, the filler element is placed between 2 polyester comprising layers, for instance a felt or fibrous layer with a low melting polyester and a high melting polyester component in the form of fibers, filaments or bicomponent fibers or filaments. Surprisingly, by using polyester based layers together with the polyester bead foam it is possible to adhere the fibrous layer to the bead foam without the need of an additional adhesive layer, preferably using a steam molding process to form the trim part. To further enhance this surprising effect a surface treatment of the bead foam element may be done, for instance a surface coating, a mechanical treatment like perforation or roughening of the surface or removing the surface layer, or a chemical treatment or activation such as plasma or flame treatment or a primer.

Thus produced trim parts may be used as filler trim parts on smaller areas of the passenger compartment or as for instance an inner dash. By adding additional layers like the carpet system discussed before or other flooring it might be also used as a flooring module.

The filler element may be produced of expanded thermoplastic terephthalate-based polyester beads using an in-mold foaming process as known in the art.

Preferably aromatic polyester-based resin foamed particles for producing the foamed molded article may be used. The aromatic polyester-based resin may be a polyester containing an aromatic dicarboxylic acid component and a diol component, for example, polyethylene terephthalate, polypropylene terephthalate, polybutylene terephthalate, polycyclohexanedimethylene terephthalate, polyethylene naphthalate, polybutylene naphthalate, and the like, polyethylene terephthalate being preferred. The aromatic polyester resin may be used alone or in blends or as copolymer with other polyesters.

As the aromatic polyester resin, not only a petroleum-derived product but also a recycled product, or recovered from a plant-derived product, a used PET bottle or the like and regenerated may be used.

The filler element is produced by in-mold foaming of un-foamed beads comprising aromatic polyester resin and a blowing agent, such that the beads blow up and fill the space, while partly fusing to neighboring beads to form a solid element, made of bead foamed particles. The single particles may still be identifiable by sphere like particles with a foamed core and a denser foamed rim.

The filler element according to the invention may have a density of between 25 and 150 kg/m³, preferably between 25 and 45kg/m³.

Preferably the filler or stiffening element obtained has a compressional stiffness of less than 1500 kPa, preferably between 150 and 1300 kPa, always at 25% compression measured according to ISO 844.

The filler element according to the invention has a low thermal conductivity as well as excellent dynamic cushioning. Hence the use of such filler or spacer elements between the body of the vehicle and the trim part surface, preferably integrated into the lower layers of the trim part, the layers not facing the passenger compartment, may increase the thermal insulation of the passenger compartment. This is in particular important for battery electric vehicles where the heating of the passenger compartment is related to the energy consumption of the car.

Preferably the filler element further comprises a reinforcing element, preferably in the form of at least one of a reinforcing rod, reinforcing fabric or reinforcing grid. The reinforcing element may be adjacent and bound to the surface of the filler element and/or enclosed at least partially within the beads of the filler element. Preferably the reinforcing element is integrated into the filler element during the in-mold foaming process. The reinforcing element is preferably of the same type of polyester as the filler element, preferably a terephthalate based polyester.

As filler elements, as used in automotive trim parts, may be thinner layers, the reinforcing element may prevent snapping or breaking of the part, in particular in thinner areas.

Automotive trim parts are also known as soft trim and are based on softer materials like foams and felts to enhance the comfort of the passenger during driving. Hence the additional layers will not directly add any stiffness to the filler or spacer element, albeit some increase of stiffness may be observed by the effect of multiple layers.

Additional layers adjacent to the filler element may be bound by polymeric binders such as hot melts, powders, films, or fibers with a melting point below 180° C. Binders may also be used within the layers for the purposes of fiber binding or tuft locking.

The additional layers may be porous or non-porous to optimize acoustics, either in an absorptive system with a defined air flow resistance or in a spring-mass system with a filled thermoplastic elastomeric layer and a fibrous or foam layer with a lower compressive stiffness and density.

An automotive trim part according to the invention comprises at least one filler element and at least one additional layer, preferably at least one of a foam layer, felt layer, film layer, thermoplastic layer, highly filled thermoplastic elastomeric layer, or a carpet system adjacent to and touching at least partially the filler element, preferably the filler element is at least partially chemically or mechanically bound to, encapsulated within or attached to the at least one additional layer.

The additional layers may be bound to each other through the melting of fibers contained in the layers, or through the use of additional films, powders, foils, or layers which melt and adhere during the forming of the trim part.

The filler element may be bound to the additional layer by a binder or adhesive, preferably this binder or adhesive comprises a film, fibrous layer, a hot melt, a powder, or a reactive system such as a polyurethane or epoxy-based system. Surprisingly, the filler element remains unchanged despite the processing of many hot melt adhesives or for example thermally molded fibers or heated foaming processes in conjunction with the filler element.

The filler element may be treated to improve connectivity to adjacent layers, by surface roughening, activation by flame or plasma treatment, application of a chemical primer, or inclusion of additional physical binders such as clips or screws.

Furthermore, the filler element may include protrusions, ribs, and/or holes to improve interlocking with the other layers and/or to conform to the body of the vehicle, and/or to optimize the usage of materials.

Use of the automotive trim part comprising the filler element according to the invention as an interior trim part, for instance an inner dash, a carpet system, a storage compartment liner, side trims, and/or other interior soft trim components.

The filler element might be used to increase locally the stiffness or to fill a larger space between the vehicle body and the surface level necessary for the function of the part or just to reduce cost if the surrounding material is expensive.

Such a surface system would additionally comprise optionally affixed or welded materials such as heel mats and cargo nets, which would preferably comprise a terephthalate-based polyester material so as to make them recyclable along with a fully terephthalate-based polyester trim part.

One example of such a trim part according to the claims is a surface system comprising a nonwoven or tufted terephthalate based polyester surface and polyester based backing layer, laminated together, further comprising a heel pad comprising a thermoplastic polyester elastomer (TPEE) material comprising crystalline polyesters and amorphous polyethers.

This flooring system would preferably comprise substantially terephthalate-based polyesters, making it recyclable as a single part in a terephthalate-based polyester closed loop recycling stream.

### BRIEF DESCRIPTION OF DRAWINGS

FIG. 1 shows an example of a filler element according to the invention used in an automotive trim part.

FIG. 2 shows another example of a filler element according to the invention used in an automotive trim part.

FIG. 3 shows a different form of the filler element with domes according to the invention in an automotive trim part.

### DETAILED DESCRIPTION

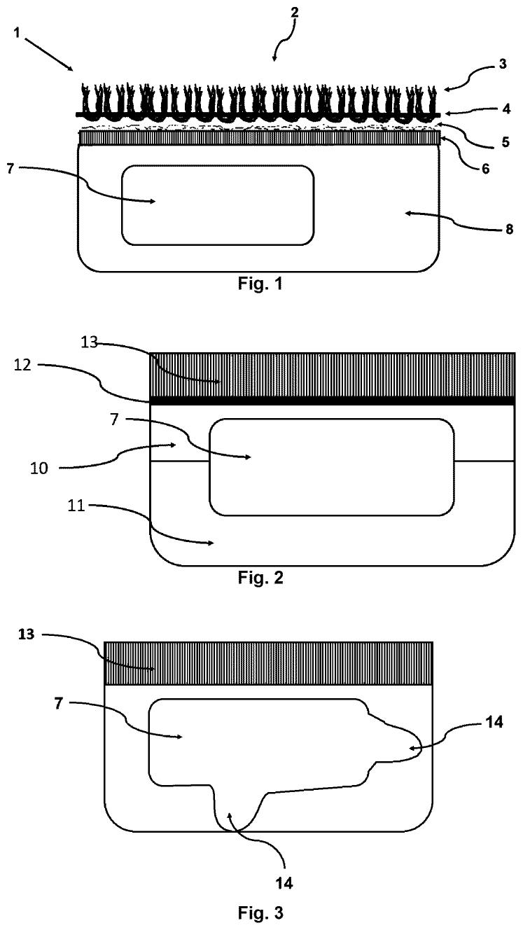

In FIG. 1, the filler element 7 may be placed upon the body of a car (not shown) and covered with a carpet system, formed by a pile of tufts 2 tufted into a primary backing whereby the tufts 3 are locked in place by a thermoplastic layer 5 attached to the surface of the primary backing 4 opposite the pile surface and with a secondary backing 6 adjacent and bonded to the thermoplastic layer.

The layer 8 surrounding the filler element, is preferably comprised of a felt or foam, more preferably a felt comprising terephthalate-based polyester fibers and a smaller amount of lower-melting bicomponent polyester fibers. This filler element may be bound to the felt or foam by an additional adhesion promoting layer (not shown).

The filler element may additionally optionally comprise a reinforcing rod or element (not shown), preferably one comprising the same terephthalate-based polyester material as the filler element.

FIG. 2 shows another example of a filler element 7, but with an alternative aesthetic surface layer such as a needle punched surface or textured thermoplastic surface 13. This surface is, in this example, bound to the rest of the part with an adhesive layer 12 which may comprise a thermoplastic hot melt formed by the melting of a powder, fiber or coated layer. The layers 10 and 11 surrounding the filler element may comprise for example multiple types or densities of felt or foam and may comprise an additional adhesive layer or treatment at the interface.

FIG. 3 shows the same part with a filler element 7 and an aesthetic textured thermoplastic or needle punched surface 13 but the filler element contains ribs, domes or protrusions 14 to assist in holding the trim part in place in the vehicle or holding within the trim part itself.

1. A filler element for use in automotive trim parts, characterized in that the filler element comprises expanded thermoplastic terephthalate-based polyester beads with a density of between 25 and 150 kg/m³.

2. A-The filler element according to claim 1, whereby the polyester beads comprise an aromatic polyester-based resin.

3. A filler element according to claim 1, whereby the element is molded into a 3D shape.

4. The filler element according to claim 1, further comprising a reinforcing element.

5. The filler element according to claim 1, whereby the filler element comprises a surface treatment.

6. An automotive trim part comprising at least one filler element according to claim 1.

7. The automotive trim part according to claim 6, whereby the filler element has a higher compressional stiffness than the surrounding layers.

8. The automotive trim part according to claim 6, further comprising at least one additional layer.

9. The automotive trim part according to claim 6, whereby the trim part comprises a first additional layer being a felt layer and, a second additional layer being a foam or felt layer, and at least one filler element whereby the filler element is at least partially sandwiched between the first and second additional layer.

10. The automotive trim part according to claim 6, whereby the trim part comprises one or more thermoplastic adhesives within materials near an interface between adjacent layers.

11. The automotive trim part according to claim 6, whereby the filler block-element comprises an outer coating binding it to at least one adjacent layer.

12. The automotive trim part according to claim 6, whereby the trim part is made entirely of polyester or co-polyester, preferably substantially of terephthalate-based polyester.

13. A method of using an automotive trim part or a filler element according to claim 1 as an inner dash, a carpet system, a storage compartment liner, side trims, other interior soft trim components, a spacer or filler block configured to fill in larger gaps between a vehicle body and a surface of the trim part, and/or as a holder for an additional component or appliance.

14. The filler element of claim 2, wherein the polyester comprises an aromatic dicarboxylic acid component and a diol component, preferably at least one of polyethylene terephthalate, polypropylene terephthalate, polybutylene terephthalate, polycyclohexanedimethylene terephthalate, polyethylene naphthalate, polybutylene naphthalate, and/or blends or copolymers thereof.

15. The filler element of claim 3, wherein the 3D shape, preferably includes at least one of ribs, voids, protrusions, channels, recesses, or domes.

16. The filler element of claim 4, wherein the reinforcing element is a reinforcing rod, a reinforcing fabric, and/or a reinforcing grid positioned adjacent and bound to a surface of the filler element and/or enclosed at least partially within the beads of the filler element.

17. The filler element of claim 5, wherein the surface treatment is at least one of a coating, a mechanical treatment, like perforation, grinding or cutting, or a chemical modification.

18. The automotive trim part of claim 8, wherein the at least one additional layer is at least one of a foam layer, felt layer, film layer, thermoplastic layer, highly filled thermoplastic elastomeric layer, or a carpet positioned adjacent and touching at least partially the filler element, wherein the filler element is at least partially bound or attached to the at least one additional layer.
